(19) United States
(12) Patent Application Publication
(10) Pub. No.: US 2005/0055227 A1
(43) Pub. Date: Mar. 10, 2005

(54) In-transit control method of minimum delivery sku

(76) Inventor: Chih-Hung Chien, Taoyuan (TW)

Correspondence Address: BIRCH STEWART KOLASCH & BIRCH, PO BOX 747, FALLS CHURCH, VA, 22040-0747, US

(21) Appl. No.: 10/656,364

(22) Filed: Sep. 8, 2003

(51) Int. Cl. G06F 17/60

(52) U.S. Cl. 705/1; 705/13; 705/23

(57) ABSTRACT

An in-transit control method of minimum delivery sku is disclosed to control the in-transit quantity of goods effectively. A minimum delivery sku is designed to manage the quantity in transit such that the quantity of the packaged goods is recorded in detail when disengaging and packaging in transit. The method involves transforming the packing number, pallet number and carton number into a unique minimum delivery sku; outputting the minimum delivery sku; and employing the minimum delivery sku to control the in-transit quantity of the goods.

### BACKGROUND OF THE INVENTION

1. Field of Invention

The invention is related to a control method of delivery goods, and more particularly to an in-transit control method of using a unique number for disengaging and re-packing goods in minimum delivery sku.

2. Related Art

Goods are packaged before delivery. The goods of the same type are packed into cantons, which are then placed on pallets. If the goods need to be transported to other countries, the pallets are placed into containers and sent to their destinations via surface transportation. In order to assure the attributes and the quantity of the in-transit goods, the goods are examined at maritime customs. The unconformity and problem goods may be distressed by the custom. Thus the examined goods may need to be re-packaged. This cause the quantity received by the buyers to be different than the quantity sent by the sellers.

Traditionally, most transportation documents and in-transit control are separated in delivery management so that the related data is keyed in accurately between the sellers and buyers. After the sellers send out the trade document, the data needs to be input into the database for controlling the delivery status. The in-transit quantity is input according to the document. However, the packing number, the carton number and the pallet number do not show the package approach and the package quantity such that a trade document must be reproduced when re-packing is necessary in transportation. The process is too complicated and often results in human error. Therefore, an easy and convenient method is necessary to solve the above-mentioned problems.

### SUMMARY OF THE INVENTION

The main object of the invention is to provide an in-transit control method for the minimum delivery sku to solve the aforementioned problems when delivering goods internationally. A minimum delivery sku is designed to manage the quantity in transit such that the quantity of the packaged goods is recorded in detail when disengaging and packaging in transit.

The term “sku” (store keeping units) has been used to identify the storage unit or single product. It is the minimum product classification unit in storage management or product management for the manufacturer or the distributor.

The main flow chart of the in-transit control method for minimum delivery sku involves inputting the data of goods, including the packing number, the pallet number, and the carton number. After obtaining the packing number, the pallet number, and the carton number, they are transformed into a unique minimum delivery sku and the minimum delivery sku is output. The minimum delivery sku is employed for goods in transit in order to control the in-transit quantity of goods effectively.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows a flow chart of the in-transit control method of minimum delivery sku of the invention.

### DETAILED DESCRIPTION OF THE INVENTION

The invention is an in-transit control method of the minimum delivery sku. For the disengaging and packing operations in goods transportation, the minimum delivery sku is designed for managing the in-transit quantity of goods. The minimum delivery sku is the minimum unit in the whole delivery process and cannot be sub-divided. Since the minimum delivery sku is unique, it can be adopted as the basic unit of data transmission for Enterprise Resource Planning (ERP) systems or remote computers.

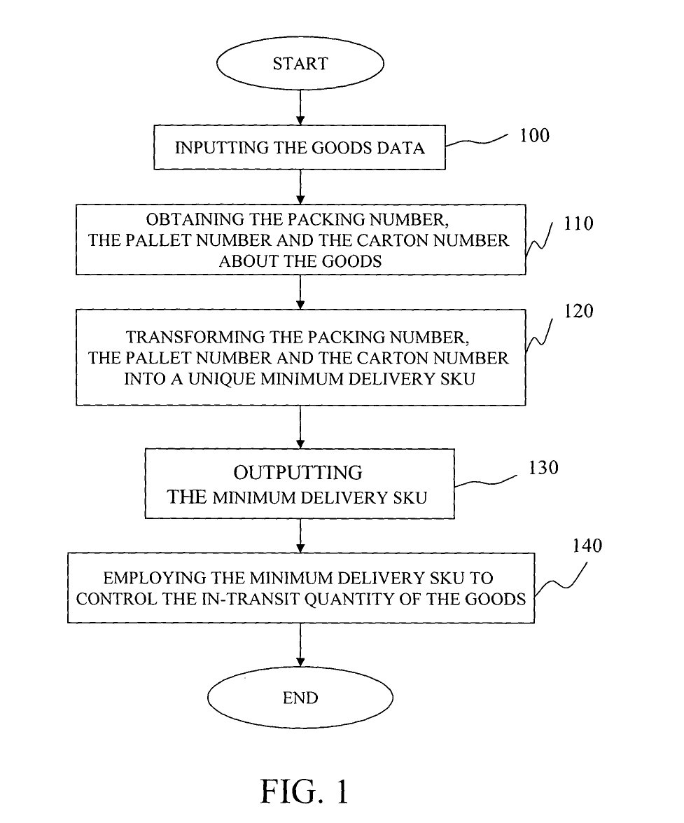

A preferred embodiment described below illustrates the viability of the in-transit control method of minimum delivery sku. Please refer to FIG. 1, which shows the flow chart of the in-transit control method of minimum delivery sku of the invention, and how the minimum delivery sku is applied in transportation management of the packaged goods.

Before establishing the minimum delivery sku of the goods and the materials, goods data has to be input first (Step 100). The goods data include a packing number, a pallet number and a carton number. After obtaining the packing number, the pallet number and the carton number (Step 110), they are transformed into a unique minimum delivery sku (Step 120), which is then output (Step 130). The minimum delivery sku is used as a key for controlling the goods data and to control the in-transit quantity of goods. (Step 140) The products can be defined in different ways for different materials numbers of different suppliers or clients. Therefore, while the products have different names or materials numbers, they can also be corresponded to goods numbers or names of different goods by the staff in the distribution center.

The company number, the trade document number, and the package number in a trade document are transformed into a traceable unique number. The unique number is adopted as a basic unit of the in-transit quantity. When re-packing is needed in transportation, the unique number is provided for selecting operations of the remote computer system. The selected unique number is then used to generate a new trade document and for maintaining and updating the in-transit quantity. The unique number can also be used as a basis for linking the product number and the product quality, and for linking the staring point and the terminal point of the goods delivery. For the staff in the remote distribution center, the unique number can also be used to give a definite command to the staff performing the distribution operations of checking, re-manufacturing, and tarrying the goods.

The advantages of the invention can be clearly understood through the analysis mentioned above and as listed in the following. The minimum delivery sku generated according to the composition of the packing number, pallet number and carton number can be used as a basic unit for system management to solve the problems of poor quality and maintenance, and the related management, for example, by integrating customs data when maritime customs requires return of goods. Furthermore, the minimum delivery sku can be applied to generate the packing list, to manage the quality of the in-transit goods, and to change the in-transit quantity of the re-packing goods.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An in-transit control method of minimum delivery sku, for controlling the quantity of disengaging and packing in-transit goods, comprising the following steps:
inputting the goods data;
obtaining the packing number, the pallet number and the carton number about the goods;
transforming the packing number, the pallet number and the carton number into a unique minimum delivery sku;
outputting the minimum delivery sku; and
employing the minimum delivery sku to control the in-transit quantity of the goods.

2. The method of claim 1, wherein the minimum delivery sku is a composition of the packing number, the pallet number and the carton number.

3. The method of claim 1, wherein the goods data is selected from one of the group consisting of the packing number, the pallet number, the carton number, a company number, a trade document number, a product number, a quantity of goods.

4. The method of claim 3, wherein the minimum delivery sku is a composition of the packing number, the pallet number, the carton number and the company number.

5. The method of claim 3, wherein the minimum delivery sku is a composition of the packing number, the pallet number, the carton number, the company number, and the trade document number.

6. The method of claim 3, wherein the minimum delivery sku is a composition of the packing number, the pallet number, the carton number, the company number, the trade document number, and the product number.

7. The method of claim 1, wherein the minimum delivery sku is the basic unit of controlling the goods.
